(19) United States
(12) Patent Application Publication
(10) Pub. No.: US 2006/0279507 A1
(43) Pub. Date: Dec. 14, 2006

(54) Liquid crystal display device

(76) Inventors: Kenji Nakao, Kanazawa-shi (JP); Tetsuya Kojima, Ishikawa-gun (JP); Kentaro Teranishi, Kanazawa-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/505,885

(22) Filed: Aug. 18, 2006

Related U.S. Application Data
(63) Continuation of application No. PCT/JP05/02651, filed on Feb. 18, 2005.

(30) Foreign Application Priority Data
Feb. 20, 2004 (JP) 2004-045211

(51) Int. Cl. G09G 3/36

(52) U.S. Cl. 345/98

(57) ABSTRACT

A liquid crystal display device includes a liquid crystal display element section that is initialized such that the alignment state of liquid crystal molecules is transitioned from a splay alignment to a bend alignment capable of displaying an image, and a driving circuit DR that cyclically applies, after the initialization, to the liquid crystal display element section a reverse transition prevention voltage, which prevents reverse transition from the bend alignment to the splay alignment, and a display voltage corresponding to a display signal supplied externally. In particular, the driving circuit DR is configured to alter a reverse transition prevention driving condition on the basis of a field frequency of the display signal.

### CROSS-REFERENCE TO RELATED APPLICATIONS

This is a Continuation Application of PCT Application No. PCT/JP2005/002651, filed Feb. 18, 2005, which was published under PCT Article 21(2) in Japanese.

This application is based upon and claims the benefit of priority from prior Japanese Patent Application No. 2004-045211, filed Feb. 20, 2004, the entire contents of which are incorporated herein by reference.

### BACKGROUND OF THE INVENTION

1. Field of the Invention

The present invention relates to a liquid crystal display device that uses OCB (Optically Compensated Bend) liquid crystal display elements in order to display an image.

2. Description of the Related Art

The liquid crystal display device includes a liquid crystal display panel that constitutes a matrix array of OCB liquid crystal display elements. The liquid crystal display panel includes an array substrate in which a plurality of pixel electrodes are covered with an alignment film and arrayed in a matrix, a counter-substrate in which a counter-electrode is covered with an alignment film and disposed so as to face the pixel electrodes, and a liquid crystal layer that is held between the array substrate and the counter-substrate in contact with each of the alignment films. Further, the liquid crystal display panel is configured such that a pair of polarizers are attached to the array substrate and the counter-substrate via optical retardation plates. Each of the OCB liquid crystal display elements serves as a pixel in a range of the associated pixel electrode. In the OCB liquid crystal display element, the alignment state of liquid crystal molecules needs to be transitioned from a splay alignment to a bend alignment capable of displaying an image, with the application of a transition voltage that is different from a normal driving voltage.

In the OCB liquid crystal display element, if a voltage of a predetermine level or more is not continuously applied for a predetermined time period or more, the bend alignment cannot be maintained and is reversely transitioned to the splay alignment. In order to prevent such a reverse transition phenomenon, a reverse transition prevention voltage is generally applied to the OCB liquid crystal display element. Jpn. Pat. Appln. KOKAI Publication No. 2002-107695 discloses a technique wherein the pulse width of the reverse transition prevention voltage is varied in accordance with a variation in ambient temperature of the liquid crystal display device.

However, even if the pulse width of the reverse transition prevention voltage is varied, it is difficult to completely prevent the reverse transition phenomenon.

### BRIEF SUMMARY OF THE INVENTION

An object of the present invention is to solve the above-described problem by providing a liquid crystal display device that is capable of completely prevent a reverse transition phenomenon.

According to the present invention, there is provided a liquid crystal display device comprising: a liquid crystal display element section that is initialized such that the alignment state of liquid crystal molecules is transitioned from a splay alignment to a bend alignment capable of displaying an image; and a driving circuit that cyclically applies, after the initialization, to the liquid crystal display element section a reverse transition prevention voltage, which prevents reverse transition from the bend alignment to the splay alignment, and a display voltage corresponding to a display signal supplied externally, the driving circuit being configured to alter a reverse transition prevention driving condition on the basis of a field frequency of the display signal.

In this liquid crystal display device, the reverse transition prevention driving condition is altered in accordance with the field frequency of the display signal. Thus, the driving condition can be optimized with respect to a reverse transition phenomenon that depends on the field frequency. Therefore, the reverse transition phenomenon can completely be prevented.

### BRIEF DESCRIPTION OF THE SEVERAL VIEWS OF THE DRAWING

FIG. 1 is a diagram schematically showing the circuit configuration of a liquid crystal display device according to an embodiment of the present invention;

FIG. 2 is a diagram showing a partial cross-sectional structure of a liquid crystal display panel shown in FIG. 1;

FIG. 3 a diagram showing the circuit configuration of an OCB liquid crystal display element that performs display for one pixel with the cross-sectional structure shown in FIG. 2;

FIG. 4 is a diagram showing the alignment state of liquid crystal molecules, which is transitioned from a splay alignment to a bend alignment by a transition voltage that is applied as a liquid crystal application voltage to the OCB liquid crystal display element shown in FIG. 3;

FIG. 5 is a waveform diagram for explaining an initialization operation for the liquid crystal display device shown in FIG. 1;

FIG. 6 is a waveform diagram for explaining a display operation of the liquid crystal display device shown in FIG. 1;

FIG. 7 is a graph showing a relationship between a black insertion ratio and a field frequency of a display signal obtained by a controller shown in FIG. 1;

FIG. 8 is a graph showing a relationship between a white level display voltage and a field frequency of a display signal obtained by a modification of the controller shown in FIG. 1;

FIG. 9 shows a modification of the liquid crystal display panel and backlight source shown in FIG. 1;

FIG. 10 is a view for explaining a field-sequential drive scheme, which is adapted to the modification shown in FIG. 9;

FIG. 11 is a view for explaining an image that is compounded by the field-sequential drive scheme shown in FIG. 10;

FIG. 12 is a view for explaining a field-sequential drive scheme, in which a black insertion period in the field-sequential drive scheme shown in FIG. 10 is discretely assigned to red, green and blue display periods; and

FIG. 13 is a graph showing a relationship between a black insertion ratio and a field frequency of a display signal obtained in the field-sequential drive scheme shown in FIG. 12.

### DETAILED DESCRIPTION OF THE INVENTION

A liquid crystal display device according to an embodiment of the present invention will now be described with reference to the accompanying drawings.

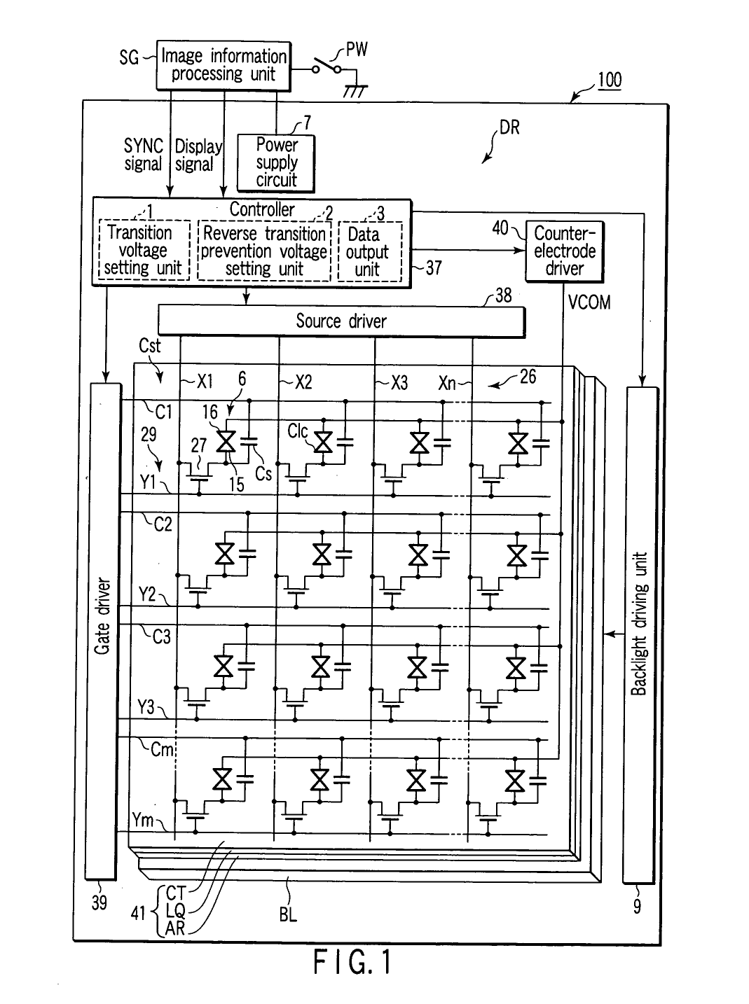

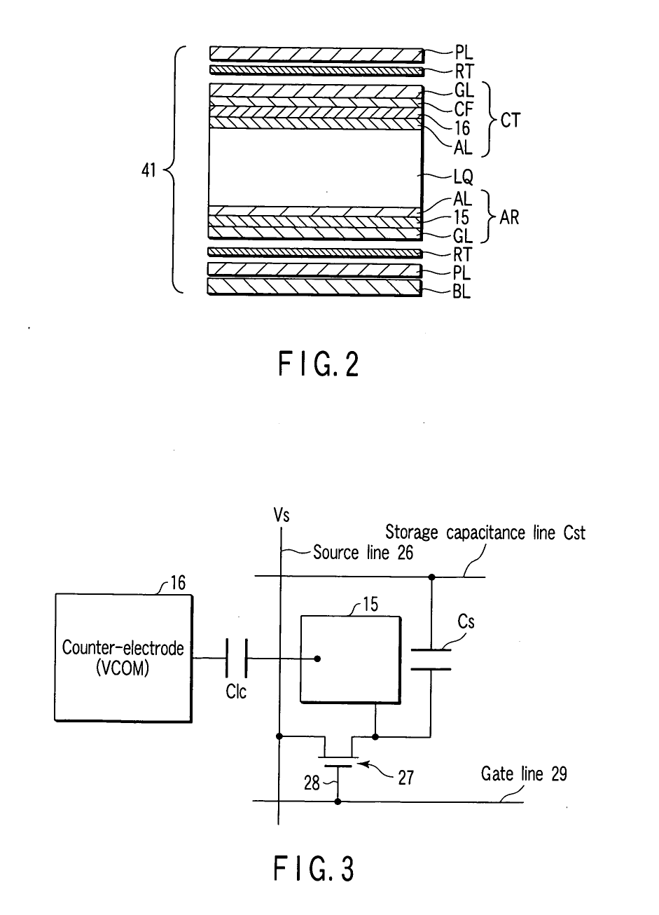

FIG. 1 schematically shows the circuit configuration of the liquid crystal display device 100, FIG. 2 shows a partial cross-sectional structure of a liquid crystal display (LCD) panel 41 shown in FIG. 1, and FIG. 3 shows the circuit configuration of an OCB liquid crystal display element 6 that performs display for one pixel with the cross-sectional structure shown in FIG. 2.

The liquid crystal display device 100 is connected to an image information process unit SG provided as an external signal source, for example, in a TV set or a mobile phone. The image information processing unit SG performs an image information process to supply a sync signal and a display signal to the liquid crystal display device 100. A power supply voltage for the liquid crystal display device is also supplied from the image information process unit SG to the liquid crystal display device 100.

The liquid crystal display device 100 includes an LCD panel 41 that constitutes a matrix array (liquid crystal display element section) of OCB liquid crystal display elements 6; a backlight BL that illuminates the LCD panel 41; and a driving circuit DR that drives the LCD panel 41 and backlight BL. The LCD panel 41 includes an array substrate AR, a counter-substrate CT, and a liquid crystal layer LQ. The array substrate AR includes a transparent insulating substrate GL that is formed of, e.g. a glass plate; a plurality of pixel electrodes 15 that are formed on the transparent insulating substrate GL; and an alignment film AL that covers the pixel electrodes 15. The counter-substrate CT includes a transparent insulating substrate GL that is formed of, e.g. a glass plate; a color filter layer CF that is formed on the transparent insulating substrate GL; a counter-electrode 16 that is formed on the color filter layer CF; and an alignment film AL that covers the counter-electrode 16. The liquid crystal layer LQ is obtained by filling a liquid crystal in a gap between the counter-substrate CT and array substrate AR. The color filter layer CF includes a red color layer for red pixels, a green color layer for green pixels, a blue color layer for blue pixels, and a black color (light-shielding) layer for a black matrix. In addition, the LCD panel 41 includes a pair of retardation plates RT that are disposed on the outside of the array substrate AR and counter-substrate CT, and a pair of polarizers PL that are disposed on the outside of the retardation plates RT. The backlight BL is a white light source, such as a cold-cathode fluorescent tube, and is disposed on the outside of the polarizer PL that is disposed on the array substrate AR side. The alignment film AL on the array substrate AR side and the alignment film AL on the counter-substrate CT side are subjected to rubbing treatment in parallel directions.

In the array substrate AR, the plural pixel electrodes 15 are arrayed substantially in a matrix on the transparent insulating substrate GL. In addition, a plurality of gate lines 29 (Y1 to Ym) are disposed along the rows of pixel electrodes 15, and a plurality of source lines 26 (X1 to Xn) are disposed along the columns of pixel electrodes 15. A plurality of pixel switches 27 are disposed near intersections between the gate lines 29 and source lines 26. Each of the pixel switches 27 is composed of a thin-film transistor that has a gate 28 connected to the gate line 29, and a sour-drain path connected between the source line 26 and the pixel electrode 15. When the thin-film transistor is driven via the associated gate line 29, the thin-film transistor is rendered conductive between the associated source line 26 and the associated pixel electrode 15.

Each of the liquid crystal display elements 6 has a liquid crystal capacitance C1c between the pixel electrode 15 and the counter-electrode 16. Each of a plurality of storage capacitance lines Cst (C1 to Cm) is capacitive-coupled to the pixel electrode 15 of each liquid crystal display element 6 on the associated row, thereby constituting a storage capacitance Cs.

The driving circuit DR is configured to control the transmittance of the LCD panel 41 by a liquid crystal application voltage that is applied to the liquid crystal layer LQ from the array substrate AR and counter-substrate CT. Each of the OCB liquid crystal display elements 6 serves as a pixel in a range of the associated pixel electrode 15. In the OCB liquid crystal display element 6, the alignment state of liquid crystal molecules needs to be transitioned from a splay alignment to a bend alignment capable of displaying an image, with the application of a transition voltage that is different from a normal driving voltage. For this purpose, each time the power switch PW is turned on, the driving circuit DR applies the transition voltage as a liquid crystal application voltage to the liquid crystal layer LQ, thereby performing initialization to transition the alignment state of liquid crystal molecules from the splay alignment to the bend alignment.

Specifically, the driving circuit DR comprises a gate driver 39 that sequentially drives the gate lines 29 to turn on the switching elements 27 on a row-by-row basis; a source driver 38 that outputs pixel voltages Vs to the source lines 26 while the switching elements 27 on each row are kept conductive by the driving of the associated gate line 29; a counter-electrode driver 40 that drives the counter-electrode 16 of the LCD panel 41; a backlight driving unit 9 that drives the backlight BL; a controller 37 that controls the gate driver 39, source driver 38, counter-electrode driver 40 and backlight driving unit 9; and a power supply circuit 7 that generates a plurality of internal power supply voltages, which are necessary for the gate driver 39, source driver 38, counter-electrode driver 40, backlight driving unit 9 and controller 37, from power (specifically, power supply voltage) that is supplied from the image information processing unit SG to the driving circuit DR.

The controller 37 outputs to the gate driver 39 a vertical timing control signal that is generated on the basis of the sync signal input from the image information processing unit SG. The controller 37 outputs to the source driver 38 a horizontal timing control signal and pixel data for one horizontal line, which are generated on the basis of the sync signal and display signal input from the image information processing unit SG. In addition, the controller 37 outputs an illumination control signal to the backlight driving unit 9. The gate driver 39 sequentially selects the gate lines 29 in one frame period under the control of the vertical timing control signal, and outputs to the selected gate line 29 a gate driving voltage that renders conductive the pixel switches 27 on the associated row for one horizontal scan period H. The source driver 38 converts, under the control of the horizontal timing control signal, pixel data for one horizontal line to pixel voltages (display voltages) Vs during the one horizontal scan period H in which the gate driving voltage is output to the selected gate line 29, and outputs the pixel voltages Vs to the plural source lines 26 in parallel.

The pixel voltage Vs is a voltage that is applied to the pixel electrode 15 with a common voltage VCOM used as a reference and output from the counter-electrode driver 40 to the counter-electrode 16. For example, the polarity of the pixel voltage Vs is reversed with respect to the common voltage VCOM in a frame-reversal drive scheme or a line-reversal drive scheme. When the switching elements 27 for one row are rendered nonconductive, the gate driver 39 applies a compensation voltage to a storage capacitance line Cst corresponding to the gate line 29 that is connected to these switching elements 27, thereby compensating variations in the pixel voltages Vs, which occur in the liquid crystal display elements 6 for one row due to the parasitic capacitances of the switching elements 27.

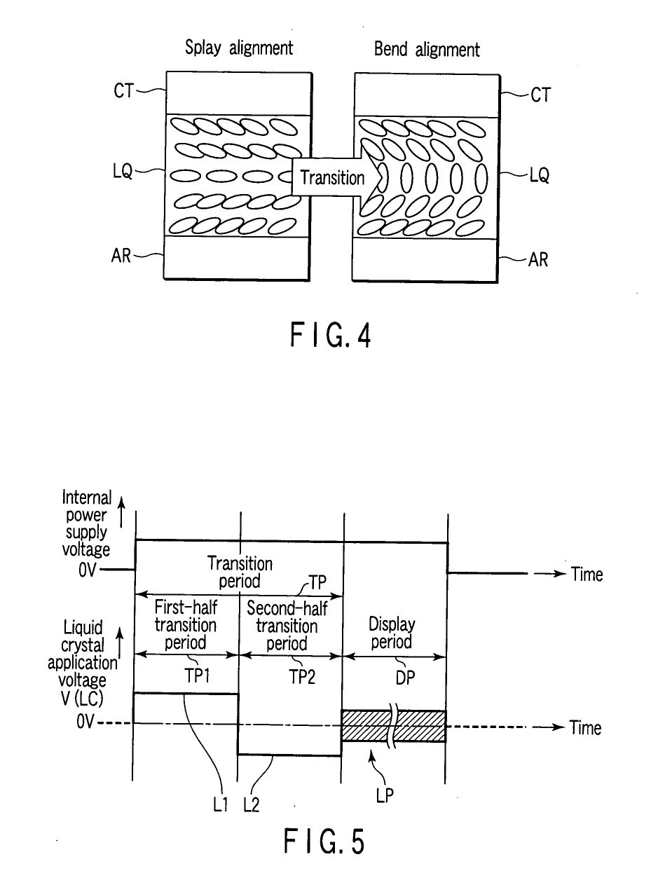

In the liquid crystal display device 100, the controller 37 includes a transition voltage setting unit 1 that performs a transition voltage setting process for setting a transition voltage to be applied to each liquid crystal display element 6 as a liquid crystal application voltage for initialization to transition the alignment state of liquid crystal molecules from the splay alignment to the bend alignment, as shown in FIG. 4; a reverse transition prevention voltage setting unit 2 that performs a reverse transition prevention process for setting a reverse transition prevention voltage to be applied to each liquid crystal display element 6 as a liquid crystal application voltage in order to prevent reverse transition from the bend alignment to the splay alignment after the initialization; and a data output unit 3 that outputs to the source driver 38 a display voltage that is a display signal for each liquid crystal display element 6, the reverse transition prevention voltage, and pixel data for transition voltage. The display voltage and the reverse transition prevention voltage are so set that the potential of the pixel electrode 15 determined by the pixel voltage Vs from the source driver 38 may shift in a predetermined form in relation to the potential of the counter-electrode 16 determined by the common voltage VCOM from the counter-electrode driver 40. The transition voltage is so set that the potential of the counter-electrode 16 determined by the common voltage VCOM from the counter-electrode driver 40 may shift in a predetermined form in relation to the potential of the pixel electrode 15 determined by the pixel voltage Vs from the source driver 38.

The liquid crystal display device 100 operates, as shown in FIG. 5, with a power supply voltage that is supplied from the image information processing unit SG to the driving circuit DR.

The power supply circuit 7 converts the power supply voltage to a plurality of internal power supply voltages, and supplies the internal power supply voltages to the controller 37, source driver 38, gate driver 39, counter-electrode driver 40 and backlight driving unit 9. The transition voltage setting unit 1 performs the transition voltage setting process for applying the transition voltage as a liquid crystal application voltage to each liquid crystal display element 6. In the transition voltage setting process, a transition period TP of about 0.6 second is set. In the transition period TP, the transition voltage is alternately changed to values with different polarities, which cause the alignment state of liquid crystal molecules to be transitioned from the splay alignment to the bend alignment. A preset value L0 is substantially 0 V, and the absolute value of each of the values with different polarities is about 25 V. The transition period is further divided into a first-half transition period TP1 of about 0.3 second and a second-half transition period TP2 of about 0.3 second. The transition voltage is set at a value L1 of a first polarity, i.e. a positive polarity, in the first-half transition period TP1, and set at a value L2 of a second polarity, i.e. a negative polarity, in the second-half transition period TP2. In this case, the pixel voltage Vs is fixed, and the common voltage VCOM output from the counter-electrode driver 40 is varied so as to obtain the above-described transition voltage.

In a subsequent video display period DP, the controller 37 fixes the common voltage VCOM to be output from the counter-electrode driver 40, and controls the source driver 38, gate driver 39 and counter-electrode driver 40 to apply a liquid crystal application voltage obtained by varying the pixel voltage Vs in accordance with the pixel data, to each liquid crystal display element 6. The controller 37 controls the backlight driving unit 9 to keep the backlight BL in an off-state in the transition period, and to set the backlight BL in an on-state in the display period DP. Thereby, the matrix array of liquid crystal display elements 6 is enabled to display an image.

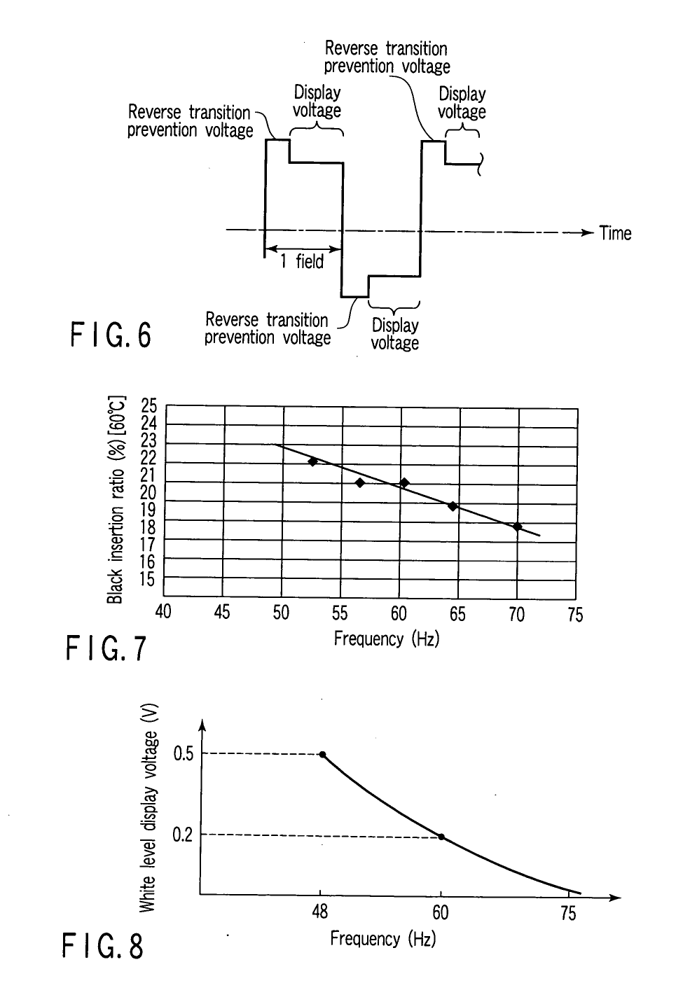

A cycle at which the display signal is updated as an image is defined as “frame”, and an inverse number of the frame is defined as “frame frequency”. A cycle, at which a pixel voltage corresponding to the display signal is written while the matrix array of the liquid crystal display elements 6 is being scanned, is defined as “field”, and an inverse number of the field is defined as “field frequency”. In a case where the display signal is input in every field, the reverse transition prevention voltage is inserted as a pixel voltage in the period of every field with a predetermined ratio, as shown in FIG. 6. In many cases, the voltage value of the reverse transition prevention voltage is set to be substantially equal to the voltage value for black display, and thus the insertion of the reverse transition prevention voltage is also referred to as “black insertion”. The ratio of the pulse width of the reverse transition prevention voltage to one field is referred to as “black insertion ratio”. In the case of executing black insertion, a time period that includes both an application period of the pixel voltage, which is the reverse transition prevention voltage, and an application period of the pixel voltage, which corresponds to the display signal, is defined as “field”.

The reverse transition prevention voltage setting unit 2 alters a reverse transition prevention driving condition, such as a voltage value or pulse width of the reverse transition prevention voltage, in accordance with the field frequency of the display signal. If the reverse transition prevention driving condition is set to be the black insertion ratio, which is the pulse width of the reverse transition prevention voltage, the data output unit 3 alternately outputs the reverse transition prevention voltage and the pixel data for display voltage to the source driver 38 in accordance with the black insertion ratio.

FIG. 7 shows a relationship between the black insertion ratio and the field frequency of the display signal obtained by the controller 37. In FIG. 7, the abscissa indicates the field frequency of the display signal, and the ordinate indicates the black insertion ratio. The black insertion ratio is set, for example, as shown in FIG. 7, in relation to the field frequency. Specifically, the black insertion ratio is set at about 22% relative to the field frequency of about 53 Hz; the black insertion ratio is set at about 21% relative to the field frequency of about 57 Hz; the black insertion ratio is set at about 21% relative to the field frequency of about 60 Hz; the black insertion ratio is set at about 20% relative to the field frequency of about 64 Hz; and the black insertion ratio is set at about 19% relative to the field frequency of about 70 Hz. In this manner, the black insertion ratio decreases as the field frequency of the display signal increases.

As has been described above, according to the present embodiment, the reverse transition prevention voltage is applied to each liquid crystal display element 6 with a pulse width or a voltage value, which depends on the field frequency of the display signal input to the liquid crystal display device 100. Thus, the reverse transition prevention voltage can be optimized with respect to various field frequencies of the display signal. As a result, the reverse transition phenomenon can completely be prevented.

In the present embodiment, the application condition of the reverse transition prevention voltage is altered as the reverse transition prevention driving condition, on the basis of the field frequency of the display signal. The present invention, however, is not limited to this embodiment. The transition voltage setting unit 1 may alter the application condition of the transition voltage in accordance with the field frequency of the display signal.

The controller 37 may be configured to vary not the application condition of the reverse transition prevention voltage, but the application condition of the display voltage, as the reverse transition prevention driving condition. FIG. 8 shows a relationship between a white level display voltage and the field frequency of the display signal obtained by a modification of the controller 37. The white level display voltage is a display voltage for displaying white. In FIG. 8, the abscissa indicates the field frequency of the display signal, and the ordinate indicates the white level display voltage. The white level display voltage is set at about 0.5 V, relative to the field frequency of 48 Hz; the white level display voltage is set at about 0.2 V, relative to the field frequency of 60 Hz; and the white level display voltage is set at about 0 V, relative to the field frequency of 75 Hz. In this case, the data output unit 2 changes the value of white level display voltage on the basis of the field frequency of the display signal. The white level display voltage is set at values, for example, as shown in FIG. 7, relative to the field frequency of the display signal.

Further, the data output unit 2 may vary the value of the white level display voltage in accordance with the ambient temperature of the liquid crystal display device. If it is assumed that the field frequency of the display signal is 60 Hz, the data output unit 2 sets the value of the white level display voltage at 0 V when the ambient temperature of the liquid crystal display device is low (e.g. 0), sets the value of the white level display voltage at 0.5 V when the ambient temperature is 40° C., and sets the value of the white level display voltage at 1 V when the ambient temperature is 60° C.

The present invention is derived from the fact that the efficiency of black insertion increases as the frequency is higher. In the above-described embodiment, the black insertion ratio is adjusted in accordance with the field frequency. The present invention, however, is not limited to this embodiment. By intentionally increasing the field frequency, the efficiency of the black insertion ratio may be enhanced. Thus, this method may be applied to a field-sequential drive scheme.

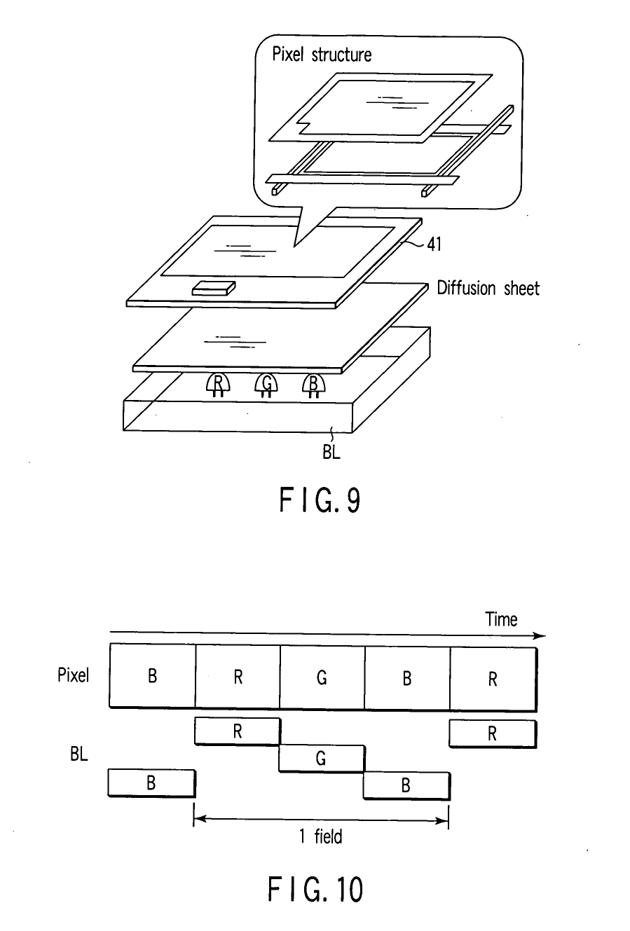

FIG. 9 shows a modification of the backlight source BL that is adapted to the field-sequential drive scheme. In the liquid crystal display panel 41, the color filter layer CF shown in FIG. 2 is not provided. Three-color LEDs that emit red, green and blue are provided as the backlight source BL in place of the cold-cathode fluorescent tube. Light from the LEDs is incident on the entire liquid crystal display panel 41 via a diffusion sheet. In this case, the controller 37 controls the backlight driving unit 9 to sequentially turn on the red LED, green LED and blue LED in, e.g. one field period, for example, as shown in FIG. 10. In addition, the controller 37 controls the source driver 38 and gate driver 39 such that display voltages are applied to all OCB liquid crystal display elements 6 as the pixel voltages during the turn-on period of each LED.

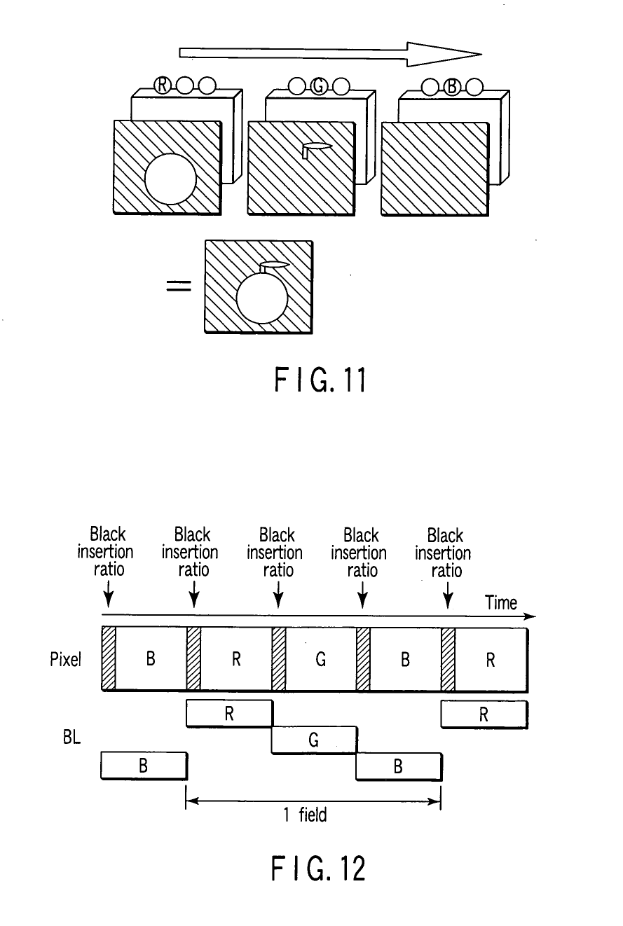

In the case where the red LED, green LED and blue LED are sequentially turned on, as described above, images of the individual colors are displayed, as shown in FIG. 11, and the images are temporally compounded in one field period into an image shown in the lower part of FIG. 11.

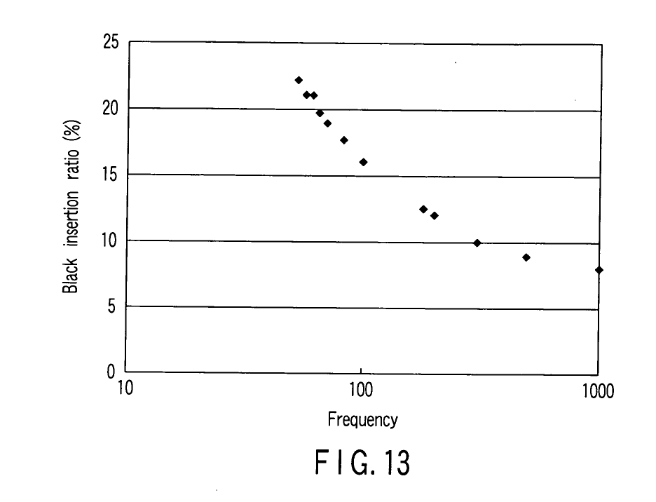

Since each of the pixels is the OCB liquid crystal display element 6, black insertion for preventing reverse transition is necessary in this modification, too. The reverse transition prevention frequency (the frequency at which the reverse transition prevention voltage is repeatedly applied) is set at 100 Hz or more. The actual black insertion period, as shown in FIG. 12, is discretely assigned to turn-on periods of the red LED, green LED and blue LED, i.e. red, green and blue display periods. In this case, the black insertion ratio to one field period, for instance, is set to vary, as shown in FIG. 13, in relation to the field frequency of the display signal. The black insertion ratio is a ratio of black insertion to a repetition cycle, that is, a ratio of a black insertion period to the field period.

In the liquid crystal display device of the field-sequential drive scheme, the number of pixels of the liquid crystal display panel 41 increases about three times as large as the number of pixels of the liquid crystal display panel 41 shown in FIG. 1. Proportionally, the field frequency becomes higher. The black insertion ratio is properly set in relation to the field frequency, and the actual value decreases. This is very advantageous since the reverse transition is prevented and also the light transmittance of the entire liquid crystal display panel 41 is enhanced.

The present invention is applicable to a liquid crystal display device that displays an image using OCB liquid crystal display elements.

What is claimed is:

1. A liquid crystal display device comprising:
a liquid crystal display element section that is initialized such that the alignment state of liquid crystal molecules is transitioned from a splay alignment to a bend alignment capable of displaying an image; and
a driving circuit that cyclically applies, after the initialization, to said liquid crystal display element section a reverse transition prevention voltage, which prevents reverse transition from the bend alignment to the splay alignment, and a display voltage corresponding to a display signal supplied externally, said driving circuit being configured to alter a reverse transition prevention driving condition on the basis of a field frequency of the display signal.

2. The liquid crystal display device according to claim 1, wherein said reverse transition prevention driving condition is a pulse width of the reverse transition prevention voltage.

3. The liquid crystal display device according to claim 1, wherein said reverse transition prevention driving condition is a voltage value of the reverse transition prevention voltage.

4. The liquid crystal display device according to claim 1, wherein said reverse transition prevention driving condition is a voltage value of the display voltage.

5. The liquid crystal display device according to claim 1, wherein said driving circuit is configured to apply the reverse transition prevention voltage a plurality of number of times during a field period of the display signal.

6. The liquid crystal display device according to claim 5, wherein a reverse transition prevention frequency, at which the reverse transition prevention voltage is repeatedly applied, is set at 100 Hz or more.

7. The liquid crystal display device according to claim 1, wherein said driving circuit is configured to drive the liquid crystal display element section by a field-sequential drive scheme.

8. The liquid crystal display device according to claim 7, wherein said reverse transition prevention voltage is inserted in each of color display periods of the liquid crystal display element section.
